(19) United States
(12) Patent Application Publication
(10) Pub. No.: US 2011/0163212 A1
(43) Pub. Date: Jul. 7, 2011

(54) Short Throw Projector Mount

(76) Inventors: Michael F. Bouissiere, Yorba Linda, CA (US); Leonard Dozier, Yorba Linda, CA (US)

(21) Appl. No.: 12/683,722

(22) Filed: Jan. 7, 2010

Related U.S. Application Data
(60) Provisional application No. 61/292,453, filed on Jan. 5, 2010.

(51) Int. Cl. A47G 29/00; B23P 11/00

(52) U.S. Cl. 248/215; 248/231.91; 29/428

(57) ABSTRACT

Disclosed is a short throw projector mount having a wall plate (12) having an arcuate front surface (26) and a projector arm (14). The projector arm (14) has a pair of hooks (52) which engage the wall plate. The arm (14) is formed of a parabolic web of material which has decreasing height from the hooks to the distal end where a projector is typically mounted.

### BACKGROUND

1. Field of the Invention

The present invention is directed to a system and method of attaching a projector to a wall for projection on that wall.

2. Description of the Related Art

Overhead projectors using plastic overlay sheets have been replaced by video projectors which receive signals from a computer and project an image on a wall or screen. The most well known software for this purpose is PowerPoint® from Microsoft Corporation. There are many manufacturers of projectors capable of projecting PowerPoint® presentations from a computer.

These projectors were either ceiling mounted or sat on a desktop distant from the screen in order to obtain the optimal magnification.

The problem with such systems is that they often had to be very distant from the screen to obtain sufficient magnification. As a consequence of the distance, light losses were extreme, thus requiring larger illumination sources and further, the projector was often located in an inconvenient place.

More recently, a new type of projector has been developed which is intended to be located close to the wall/screen. Such systems are know as “short throw” projectors. Examples of such devices are Sanyo PLCXL50 and Infocus IN1501. The optics in such projectors are radically different from standard projectors. They are capable of being located above the screen yet project the image in a rectilinear form on the screen as if the lens was dead center pointing at the screen from a greater distance.

With the advent of short throw projectors, there is a need for a mount which can suspend a projector distant from the wall/screen and can support the weight of the projector without risk of failure. It would also be helpful to provide a quick removal feature so that the projector or bulb can be quickly swapped out, and be able to restore the projector precisely to its original position without realignment. It may be important to have the ability to adjust the distance from the screen to accommodate different projector optics. Finally, it would be advantageous to be able to route store cables through the mount and out of sight.

### BRIEF SUMMARY

A summary is provided to assist the reader in getting a quick understanding of the disclosure but is not intended as a substitute therefore. It is necessary to read the entire specification, drawings and claims to appreciate the complete disclosure.

According to one aspect of the invention, there is disclosed a wall mountable short throw projector mount which may have the following components: a wall mount portion, having a top attachment edge and a front face joined to said top edge; said front having an arcuate surface and said top edge including at least two spaced part hook receiving apertures; at least one side portal defined between said front face, said top edge and the wall; at least one portal cover pivotally attached to at least said top edge, said cover having first and second edges, said first edge being generally flat to conform to the wall surface and a second edge being generally arcuate to confirm to the arcuate surface of said front face; so that when said portal cover is closed, it is generally in occluding contact with the wall surface on one edge and the inside surface of the front face on the other; a removable cantilevered extension arm having first and second ends, said first end extending from said wall portion and a second end for receiving a projector mount; said first end including a pair of spaced apart splayed hooks located to be received within said hook receiving apertures, said arm including an arcuate support web which includes at its first end, said hooks and a wall portion engagement edge, a mount engaging portion at said second end and a generally parabolic curved trough of opposed sidewalls between said ends, said trough having sidewalls of decreasing height from said hooks to said mount engaging portion and further including a first edge for contacting said front face, said first contact edge having an arcuate portion shaped to mate with the arcuate front face of said wall mount portion; a bridge member residing in said trough and attached to opposed sidewalls; said bridge member including a contact member capable of affixation to said front face; an extension receiving passage formed between said bridge and said trough; a projector mount end attached to said arm at the other end. The device does not require all of the above elements to perform advantageously and different combinations are presented herein.

According to another aspect of the invention there is disclosed a wall projector mount and storage system to be mounted on a wall having a pair of spaced apart mounting flanges, a wall plate having upper and lower edges connected to said flanges and a convex arcuate front face extending from said edges, said front face having right and left arcuate concave sides; a pair of portal doors pivotally connected to said upper and lower edges and having at least one arcuate edge shaped to mate with said concave sides, so that when said doors are pivoted into a closed position, they define a space bounded by the wall, the wall plate and said doors.

According to another aspect of the invention, there is disclosed a method constructing a reinforced cantilevered extension arm for mounting a projector a distance from a projection wall comprising the steps of forming an arm of a generally parabolic cross section having a trough and opposing sidewalls; forming a pair of spaced apart hooks at one of the distal ends of arm to be received in a wall mount; tapering the opposing sidewalls so that they are higher adjacent said hooks than distant therefrom, connecting said sidewalls by a bridge member therebetween.

According to a further aspect of the invention there is disclosed an extension arm for removable attachment to a wall mount fixture, the arm has a generally parabolic web of rigid material having proximal and distal ends, the wrap having a trough exposed upwardly and a pair of sidewalls which have a greater separation from each other as they extend upwardly from said trough; the sidewalls terminating at said trough at the distal end and at attachment points at the proximal end. The arm may further have attachment points which include a pair of hooks to be received in said wall fixture and the hooks may be outwardly splayed. The arm may have sidewalls increase gradually in height from the trough from the distal to the proximal end and may include a bridge member joining the sidewalls and thereby forming an enclosed space bounded by the trough and the bridge. The bridge may have proximal and distal end and wherein the proximal end includes an attachment point, the attachment point being attachable to the wall fixture. The trough and the bridge member may be coaxial/coplanar so that the space bounded therebetween is of generally equal volume long its length. The extension member may sized to be received within the enclosed space and a lock or set screw for fixing the position of the extension relative to the trough.

### BRIEF DESCRIPTION OF SEVERAL VIEWS OF THE DRAWINGS

FIG. 1 illustrates a perspective view of a short throw mount.

FIG. 1a Illustrates a close up view of a portion of the mount.

FIG. 2 illustrates a rear prospective view.

FIG. 3 illustrates is a front plan view of the wall plate.

FIG. 4 illustrates top plan view.

FIG. 5 illustrates side plan view.

FIG. 6 illustrates bottom perspective view.

FIG. 7 illustrates is a side plan view with extension arm.

FIG. 8 illustrates is a side plan view with a part of the projector mount attached without extension.

FIG. 9 illustrates a side plan view with part of the projector mount attached at a close wall location.

FIG. 10 illustrates an exploded parts view of the mount with extension.

FIG. 11 illustrates an exploded parts view without extension.

FIG. 12 illustrates a perspective view of an alternate embodiment with outrigger speakers.

### DETAILED DESCRIPTION

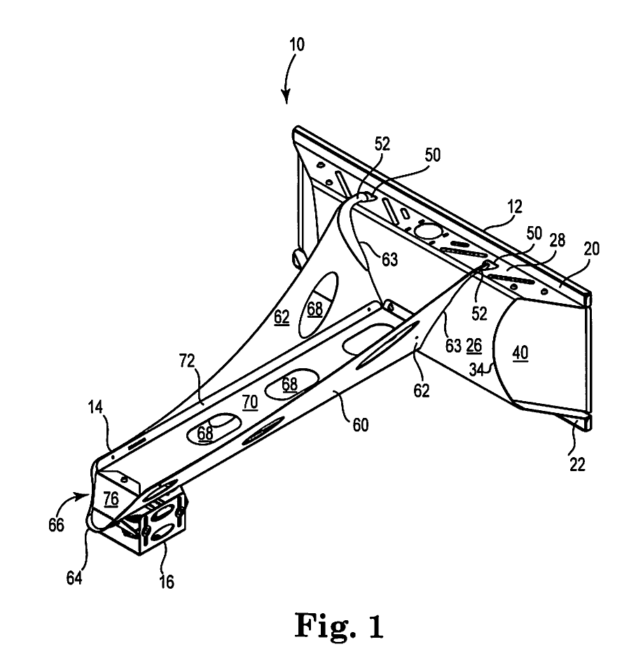

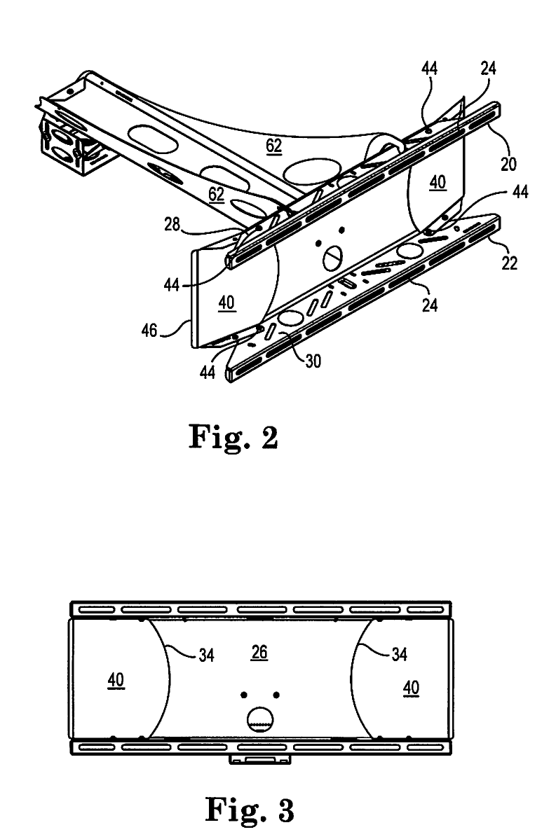

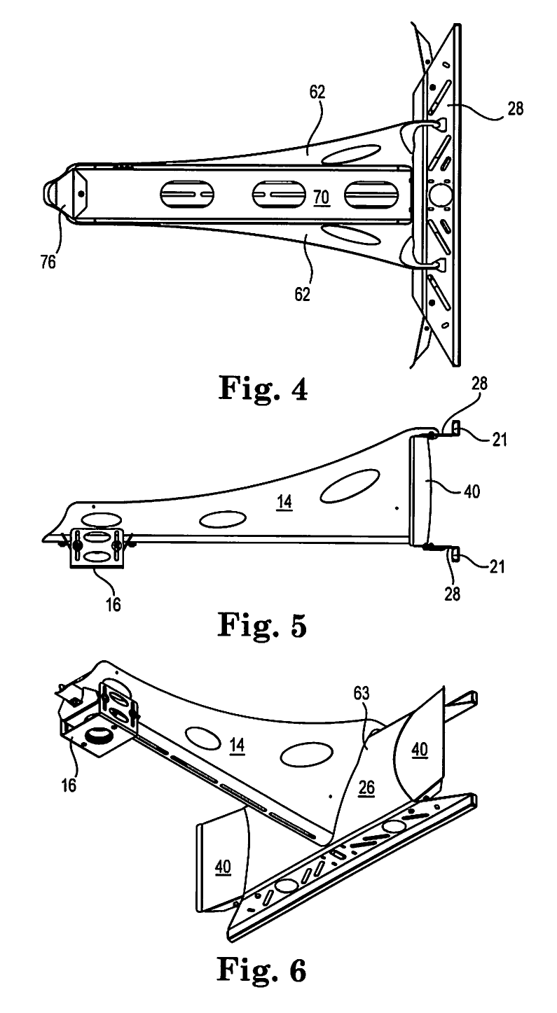

An assembled short throw mount 10 is shown in FIGS. 1-9. The mount includes a wall plate unit 12, a removable arm 14, and optionally, a tiltable projector mount fixture 16.

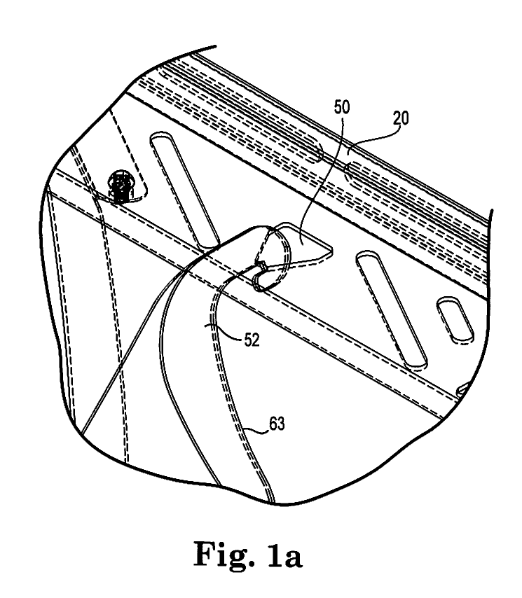

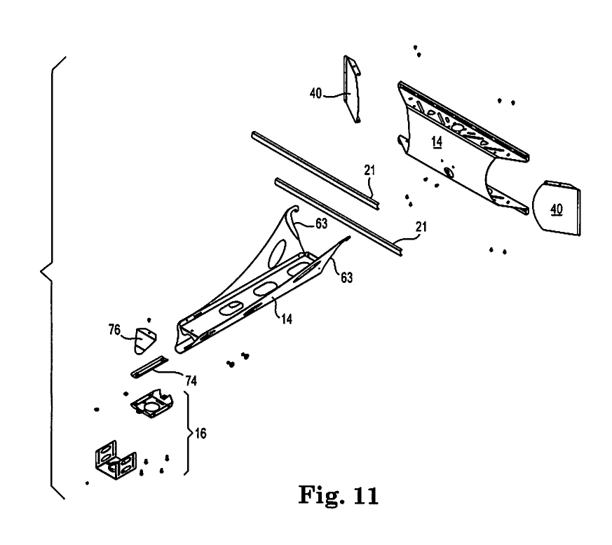

The wall plate unit 12 has mounting flanges 20, 22 (shown with covers 21 in FIGS. 1 and 11 and without in FIG. 2). The flanges include a plurality of apertures 24 which allow for wall mounting. The front face 26 joins a top edge 28 roughly at right angles, which in turn, is orthogonally connected to flanges 20, 22. A bottom edge 30 is visible in FIG. 2. The face 26 preferably follows an arcuate shape such that is convex as seen from the front. The arcuate shape of face 26 is preferably a cylindrical arc along an imaginary axis which runs coaxially with flanges 20, the axis which would be located in the wall equidistant between the flanges 20. This gives the plate strength which may be needed to support the cantilevered arm. The face 28 has arcuate concave side edges 34 which are designed to mate or conform the shape of the pivoting portal doors 40 which have mating convex edges and which pivot on points 44 which connect the wall plate to the doors. Door 40 may also include flanges 46 which extend at an obtuse angle (about 75 degrees) from the door face so that when the doors are closed, they create a visual seal between the wall surface and the wall face 26. The space created between the wall and the inner surface of the wall face 26 becomes a cable passage and storage area for parts, electronics, cabling, etc.

The top edge/surface 28 includes various mounting slots for additional features and a pair of hook cutouts 50. A close up view is shown in FIG. 1a which shows the cutout to have a pair of converging walls to a curved portion. This shape automatically directs the hooks into proper position.

The hook cutouts 50 are sized to receive hooks 52 on arm 14.

Arm 14 has a complex shape, in part to provide maximum strength and to be aesthetically pleasing. The main portion of the arm is comprised of a arcuate wrap, web or band 60 preferably in the form of a parabola opening upwardly (though the reverse is possible). The parabolic web 60 has two sidewalls 62 and a trough 64. The sidewalls have decreasing slope from the hoods 52 to the distal end 66. The exact slope and the width of the parabola are aesthetic. The oval apertures 68 are non-functional except that they function as product configuration trademarks. The edges 63 of the wrap extending from the hooks which contact the arcuate portion 26 of the wall plate 12 are formed to have substantially the same arcuate shape so that they mate or conform to the arcuate shape at many points. This helps distribute the force on face 26 and allows thinner materials to be used without point deformation.

Because the sidewalls 62 are splayed, ie spread outwardly from each other, so are hooks 52. This has a beneficial effect of helping to center the arm on the wall mount.

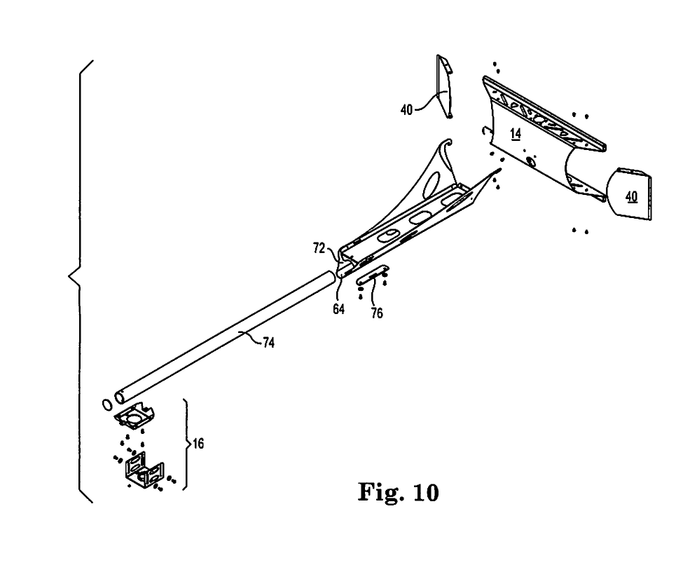

In the preferred configuration, a bridge plate 70 is placed between sidewalls 62 close to the trough 64. Trough 64 has its open end exposed upwardly and splayed sidewalls which have a greater separation from each other as they extend away from each other. Likewise the sidewalls may have increasing height as measured from the trough as they extend from the distal end to the proximal end (closest the wall). It is also possible to have the reverse configuration. The bridge plate 70 may have flanges which are welded or bolted to the sidewalls. This provides both strength, rigidity and creates a boundary aperture 72 (see FIG. 10) between the bridge plate and the trough, which can receive an extension bar 74 (FIG. 10) or a cover plate 76 (FIG. 1) if no extension is used. Backplate 76 (FIG. 10) is actually installed in the aperture space 72 and provides nuts for receiving bolts from optional elements.

In operation, the wall unit 12 is affixed to a wall or other upright structure which may also include a projection screen. The arm 14 engages hooks 52 at cutouts 50 and because the hooks are splayed, the registration between the arm and wall mount is self centering.

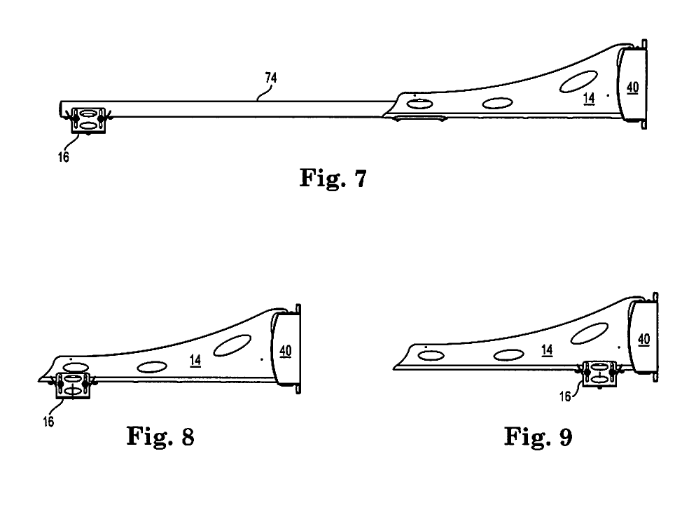

The projector (not shown) can be attached to the (projector mount end) 66 of the arm in many places, as shown in FIGS. 7-9, including with the extension bare 74. Notice that the projector mount 16 will allow the projector to be removed and replaces without realignment of the projector. Indeed, the entire arm 14 may be removed with the projector in place and alternate projectors can be installed with the use of extra arms.

This disclosure also includes a method constructing a reinforced cantilevered extension arm for mounting a projector a distance from a projection wall comprising the steps, in any order, of forming an arm of a generally parabolic cross section having a trough and opposing sidewalls, then forming a pair of spaced apart hooks at one of the distal ends of arm to be received in a wall mount and then tapering the opposing sidewalls so that they are higher adjacent said hooks than distant there from and then connecting said sidewalls by a bridge member therebetween. This method will result in a structure which is extremely strong yet lightweight because the arcuate and parabolic shapes provide considerable shape. Mating of curves further improves the strength to weigh ratio.

It is possible to reverse the parabola so that the trough is on the top instead of the bottom and the term “parabolic” is not intended to be limiting to a true parabola, but other arcuate forms are possible.

The mount is typically made entirely of steel, though plastic or other materials may be suitable. The unique structure provides very high strength thereby minimizing material requirements.

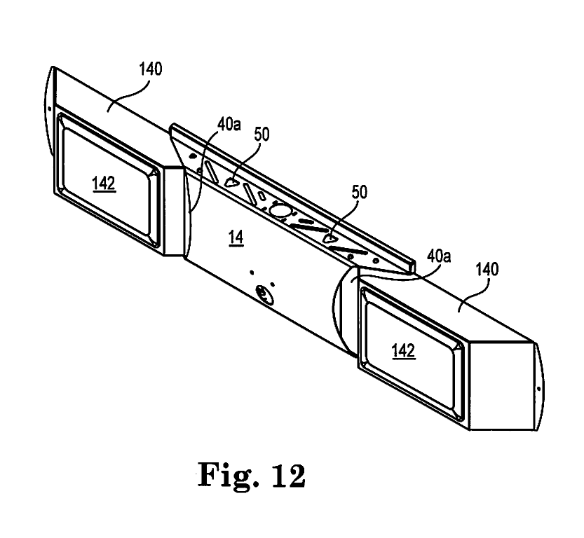

FIG. 12 illustrates an alternate embodiment where wall mount 14 is fitted with optional add on speaker units 140 which mate with the existing wall mount. These units have twin speakers 140 (if stereo is desired) and mount onto either side of mount 14. Portal doors 40a, are similar to doors 40 except they may be shorter to accommodate the engagement of speaker units 140 into the space available shorter doors or the doors removed. The speakers are connected to an amplifier (not shown) which in turn is preferably connected to the a/v equipment in the room on the mount to provide sound.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A wall mountable short throw projector mount comprising:
a. a wall mount portion, having a top attachment edge and a front face joined to said top edge; said front having an arcuate surface and said top edge including at least two spaced part hook receiving apertures;
b. a removable cantilevered extension arm having first and second ends, said first end extending from said wall portion and a second end for receiving a projector mount; said first end including a pair of spaced apart hooks located to be received within said hook receiving apertures, said arm including an arcuate support web which includes at its first end, said hooks and a wall portion engagement edge, a mount engaging portion at said second end and a generally parabolic curved trough of opposed sidewalls between said ends, said first contact edge having an arcuate portion shaped to generally conform to the arcuate front face of said wall mount portion; a bridge member residing in said trough and attached to opposed sidewalls; said bridge member including a contact member capable of affixation to said front face.

2. A wall mountable short throw projector mount comprising:
a. a wall mount portion, having a top attachment edge and a front face joined to said top edge; said front having an arcuate surface and said top edge including at least two spaced part hook receiving apertures;
b. at least one side portal defined between said front face, said top edge and the wall;
c. at least one portal cover pivotally attached to at least said top edge, said cover having first and second edges, said first edge being generally flat to conform to the wall surface and a second edge being generally arcuate to confirm to the arcuate surface of said front face; so that when said portal cover is closed, it is generally in occluding contact with the wall surface on one edge and the inside surface of the front face on the other;
d. a removable cantilevered extension arm having first and second ends, said first end extending from said wall portion and a second end for receiving a projector mount; said first end including a pair of spaced apart splayed hooks located to be received within said hook receiving apertures, said arm including an arcuate support web which includes at its first end, said hooks and a wall portion engagement edge, a mount engaging portion at said second end and a generally parabolic curved trough of opposed sidewalls between said ends, said trough having sidewalls of decreasing height from said hooks to said mount engaging portion and further including a first edge for contacting said front face, said first contact edge having an arcuate portion shaped to mate with the arcuate front face of said wall mount portion; a bridge member residing in said trough and attached to opposed sidewalls; said bridge member including a contact member capable of affixation to said front face; an extension receiving passage formed between said bridge and said trough;
e. a projector mount end attached to said arm at the other end.

3. A wall projector mount and storage system to be mounted on a wall comprising:
a. a pair of spaced apart mounting flanges,
b. a wall plate having upper and lower edges connected to said flanges and a convex arcuate front face extending from said edges, said front face having right and left arcuate concave sides;
c. a pair of portal doors pivotally connected to said upper and lower edges and having at least one arcuate edge shaped to mate with said concave sides, so that when said doors are pivoted into a closed position, they define a space bounded by the wall, the wall plate and said doors.

4. The system of claim 3 wherein said wall plate includes a pair of outrigger speaker units on either side thereof, said speaker units abutting said portal doors and including an amplifier connected thereto.

5. An extension arm for removable attachment to a wall mount fixture, said arm comprising: generally parabolic web of rigid material having proximal and distal ends, said wrap having a trough exposed upwardly and a pair of sidewalls which have a greater separation from each other as they extend upwardly from said trough; said sidewalls terminating at said trough at the distal end and at attachment points at the proximal end.

6. The arm of claim 5 wherein said attachment points include a pair of hooks to be received in said wall fixture.

7. The arm of claim 6 wherein said hooks are outwardly splayed.

8. The arm of claim 5 wherein said sidewalls increase gradually in height from the trough from the distal to the proximal end.

9. The arm of claim 5 wherein said trough includes a bridge member joining the sidewalls and thereby forming an enclosed space bounded by said trough and said bridge.

10. The arm of claim 9 wherein said bridge has a proximal and distal end and wherein said proximal end includes an attachment point, said attachment point being attachable to said wall fixture.

11. The arm of claim 9 wherein said trough and said bridge member are coaxial so that the space bounded therebetween is of generally equal volume long its length.

12. The arm of claim 9 further including an extension member sized to be received within said enclosed space and a lock for fixing the position of the extension relative to said trough.

13. A method constructing a reinforced cantilevered extension arm for mounting a projector a distance from a projection wall comprising the steps of:
a. forming an arm of a generally parabolic cross section having a trough and opposing sidewalls;
b. forming a pair of spaced apart hooks at one of the distal ends of arm to be received in a wall mount;
c. tapering the opposing sidewalls so that they are higher adjacent said hooks than distant there from
d. connecting said sidewalls by a bridge member therebetween.
